(19) United States
(12) Patent Application Publication
(10) Pub. No.: US 2005/0193880 A1
(43) Pub. Date: Sep. 8, 2005

(54) Packing machine having film conveying device and film cutting device

(76) Inventor: Yi-Chiu Chao, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/795,558

(22) Filed: Mar. 4, 2004

(51) Int. Cl. B26D 1/38

(52) U.S. Cl. 83/349; 83/674

(57) ABSTRACT

A packing machine includes a frame, a film cutting device, and a film conveying device. The film cutting device includes a fixing rack, a fixed cutter having a fixed blade, a rotation shaft, and a movable cutter having a movable blade that is rotatable to abut the fixed blade of the fixed cutter. The film conveying device includes a plurality of conveying belts each located beside the film cutting device, and an air box mounted on the conveying belts. Thus, the film conveying device has a quick conveying function so as to deliver the film rapidly and smoothly. In addition, the film cutting device has a quick cutting function so as to cut the film rapidly and smoothly.

### BACKGROUND OF THE INVENTION

1. Field of the Invention

The present invention relates to a packing machine, and more particularly to a packing machine having a film conveying device with a quick conveying function and a film cutting device with a quick cutting function.

2. Description of the Related Art

A conventional packing machine 1 in accordance with the prior art shown in FIGS. 15 and 16 comprises a frame 8, two rollers 2 mounted on the frame 8 for tensioning a film 6, a conveying system 4 mounted on the frame 8 for conveying an article 3 to be packaged, and a pneumatic cylinder 5 mounted on the frame 8 and having a piston rod 50 for pushing the article 3 toward the film 6. Thus, the pneumatic cylinder 5 pushes the article 3 toward the film 6 to move the article 3 from the position as shown in FIG. 15 to the position as shown in FIG. 16, so that the article 3 is wrapped by the film 6. Then, the film 6 is cut by a cutter (not shown) and is processed by a heat press (not shown), thereby packaging the article 3 in the film 6.

However, the article 3 is hit by the piston rod of the pneumatic cylinder 5, so that the article 3 is easily vibrated, thereby affecting package of the article 3. In addition, the conveying system 4 has to stop moving when the piston rod of the pneumatic cylinder 5 is moved forward to push the article 3 and start moving after the piston rod of the pneumatic cylinder 5 is retracted backward, so that the packaging work is performed intermittently, thereby decreasing the working efficiency.

### SUMMARY OF THE INVENTION

The primary objective of the present invention is to provide a packing machine having a film conveying device with a quick conveying function so as to deliver the film rapidly and smoothly.

Another objective of the present invention is to provide a packing machine having a film cutting device with a quick cutting function so as to cut the film rapidly and smoothly.

In accordance with the present invention, there is provided a packing machine, comprising:
a frame;
a film cutting device mounted in the frame and including a fixing rack secured on a first end of the frame, a fixed cutter secured on the fixing rack and having a distal end formed with an oblique fixed blade, a rotation shaft rotatably mounted on the first end of the frame and located above the fixing rack, and a movable cutter secured on the rotation shaft to rotate therewith and having a distal end formed with an oblique movable blade that is rotatable to abut the fixed blade of the fixed cutter; and
a film conveying device mounted in the frame and including a plurality of conveying belts each movably mounted on the first end of the frame and each located beside the film cutting device, and an air box mounted on the conveying belts for providing a suction action on the conveying belts.

Further benefits and advantages of the present invention will become apparent after a careful reading of the detailed description with appropriate reference to the accompanying drawings.

### BRIEF DESCRIPTION OF THE DRAWINGS

FIG. 1 is a plan view of a packing machine in accordance with the preferred embodiment of the present invention;

FIG. 2 is a schematic operational view of the packing machine as shown in FIG. 1;

FIG. 3 is a schematic operational view of the packing machine as shown in FIG. 2;

FIG. 4 is a schematic operational view of the packing machine as shown in FIG. 3;

FIG. 5 is a schematic operational view of the packing machine as shown in FIG. 4;

FIG. 6 is a schematic operational view of the packing machine as shown in FIG. 5;

FIG. 7 is a perspective view showing a partially packed article in accordance with the preferred embodiment of the present invention;

FIG. 8 is a perspective view showing a wholly packed article in accordance with the preferred embodiment of the present invention;

FIG. 9 is a partially perspective view of the packing machine in accordance with the preferred embodiment of the present invention;

FIG. 10 is a locally enlarged view of the packing machine as shown in FIG. 9;

FIG. 11 is a partially exploded perspective view of the packing machine as shown in FIG. 9;

FIG. 12 is a partially exploded perspective view of the packing machine as shown in FIG. 9;

FIG. 13 is a side plan cross-sectional view of the packing machine as shown in FIG. 9;

FIG. 14 is a schematic operational view of the packing machine as shown in FIG. 13;

FIG. 15 is a plan view of a conventional packing machine in accordance with the prior art; and

FIG. 16 is a schematic operational view of the conventional packing machine as shown in FIG. 15.

### DETAILED DESCRIPTION OF THE INVENTION

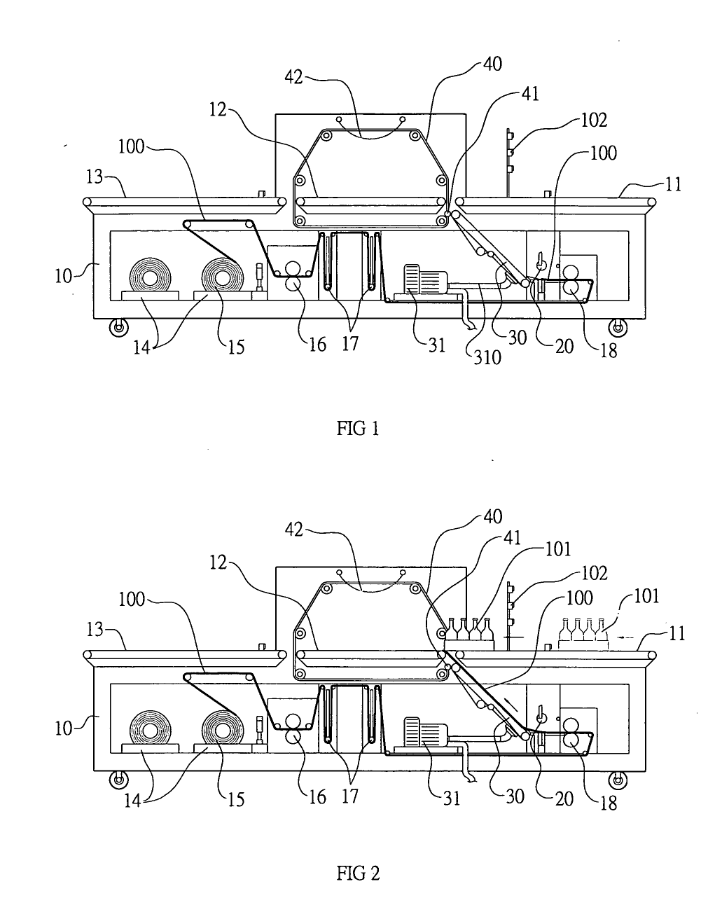

Referring to the drawings and initially to FIG. 1, a packing machine in accordance with the preferred embodiment of the present invention comprises a rectangular frame 10, a first conveying belt 11 mounted on a first end of the frame 10, a sensing device 102 mounted on the first conveying belt 11, a second conveying belt 13 mounted on a second end of the frame 10, an intermediate conveying belt 12 mounted on a mediate portion of the frame 10 and located between the first conveying belt 11 and the second conveying belt 13, two loop-shaped chain units 40 each mounted on the mediate portion of the frame 10 and located beside the intermediate conveying belt 12, a storage shelf 14 mounted in and located at the second end of the frame 10, a film roll 15 mounted on the storage shelf 14, a delivery device 16 mounted in and located at the mediate portion of the frame 10, a plurality of tension rods 17 mounted in and located at the mediate portion of the frame 10, a plurality of delivery rollers 18 mounted in and located at the first end of the frame 10, a film cutting device 20 mounted in and located at the first end of the frame 10, and an inclined arranged film conveying device 30 mounted in and located at the first end of the frame 10. Each of the two loop-shaped chain units 40 includes a drive bar 41 and a flexible belt 42.

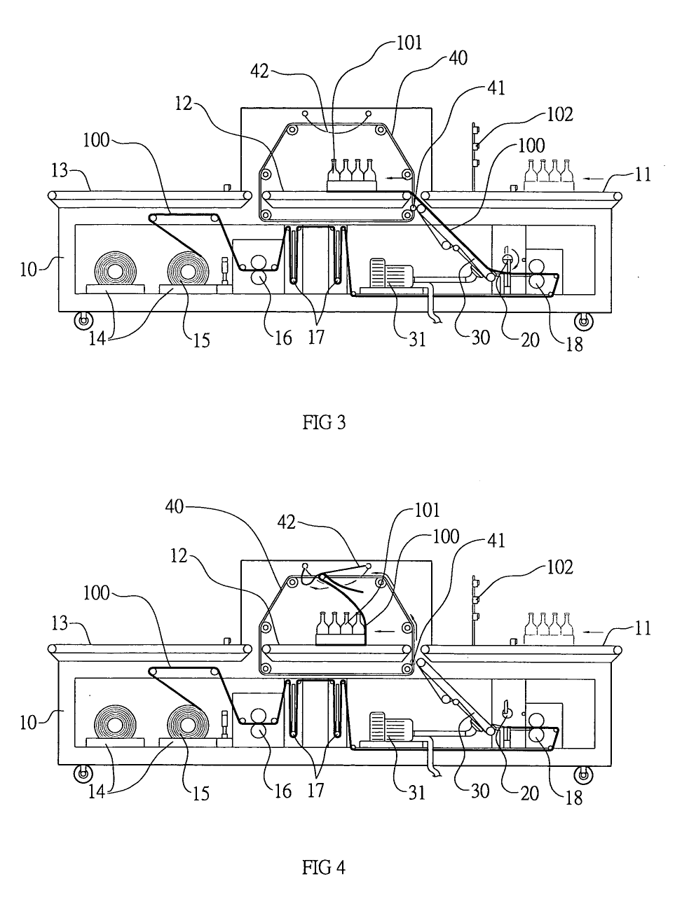

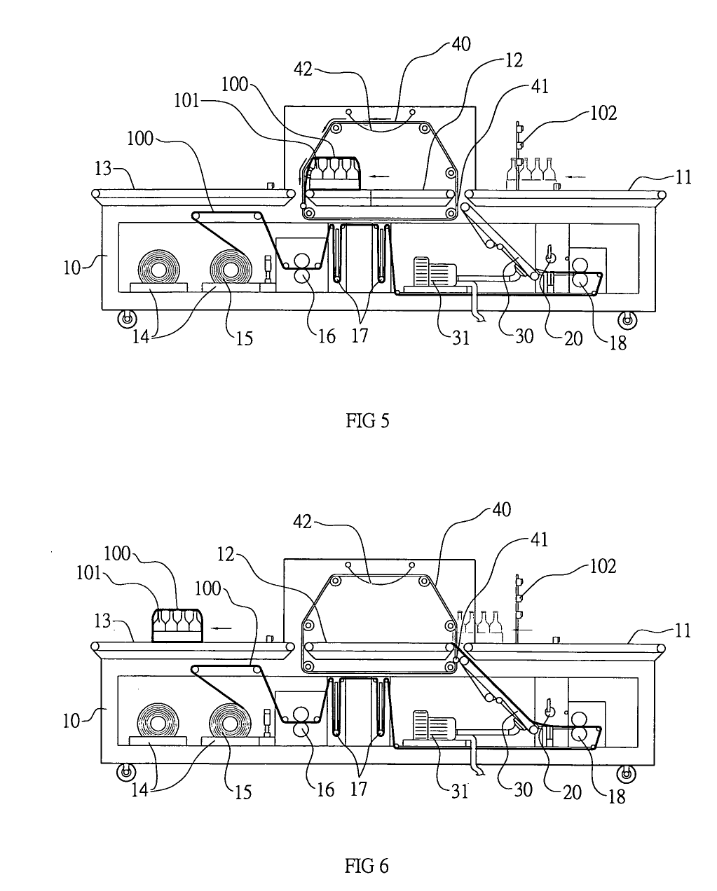

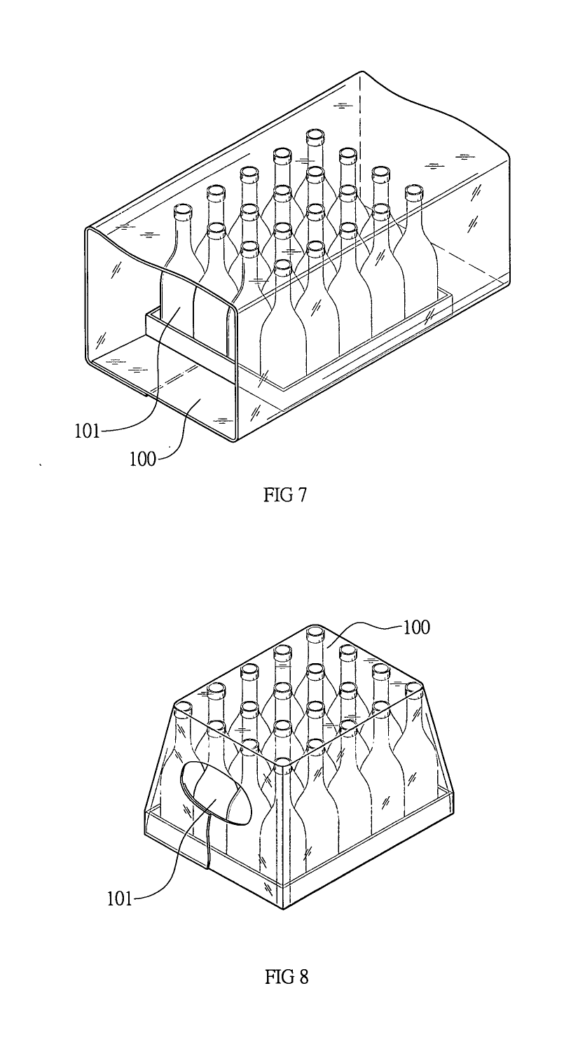

In operation, referring to FIGS. 1-8, a film 100 extended from the film roll 15 mounted on the storage shelf 14 passes through the delivery device 16, the tension rods 17 and the delivery rollers 18 and reaches the film cutting device 20 as shown in FIG. 1. When an article 101 to be packed is placed on the first conveying belt 11 and is moved toward the intermediate conveying belt 12, the sensing device 102 detects movement of the article 101, so that the film 100 is delivered by the film conveying device 30 to move toward the intermediate conveying belt 12 until a first end of the film 100 is inserted into a gap between the first conveying belt 11 and the intermediate conveying belt 12 as shown in FIG. 2. When the article 101 reaches the position as shown in FIG. 2, the bottom of the front end of the article 101 presses the first end of the film 100, so that the article 101 and the film 100 are moved forward synchronously as shown in FIG. 3. At the same time, the film cutting device 20 is operated to cut the film 100 as shown in FIG. 3, so that the film 100 having a determined length is moved forward with the article 101. After the rear end of the article 101 passes through the gap between the first conveying belt 11 and the intermediate conveying belt 12, each of the chain units 40 is operated, so that the drive bar 41 drives a second end of the film 100 to move upward as shown in FIG. 4. Then, the flexible belt 42 presses the drive bar 41, so that the film 100 is stretched to wrap the surface of the article 101 closely as shown in FIG. 5. At this time, before the front end of the article 101 passes through the gap between the intermediate conveying belt 12 and the second conveying belt 13, the second end of the film 100 is driven by the drive bar 41 into the gap between the intermediate conveying belt 12 and the second conveying belt 13, so that when the front end of the article 101 passes through the gap between the intermediate conveying belt 12 and the second conveying belt 13, the second end of the film 100 is bent and is rested on the bottom of the front end of the article 101 as shown in FIG. 6. Thus, the first and second ends of the film 100 overlap each other at the bottom of the front end of the article 101 as shown in FIG. 7, so that the article 101 is enclosed by the film 100. Finally, the article 101 is delivered by the second conveying belt 13 to perform a contraction package process, thereby wholly wrapping and packing the article 101 in the film 100 as shown in FIG. 8.

Referring to FIGS. 9-13 with reference to FIG. 1, the film cutting device 20 includes a fixing rack 24 secured on the first end of the frame 10, a fixed cutter 25 secured on the fixing rack 24 by a plurality of locking bolts 26 and having a distal end formed with an oblique fixed blade 252, a rotation shaft 21 rotatably mounted on the first end of the frame 10 and located above the fixing rack 24, and a movable cutter 23 secured on the rotation shaft 21 to rotate therewith and having a distal end formed with an oblique movable blade 232 that is rotatable to abut the fixed blade 252 of the fixed cutter 25 to cut the film 100. The film cutting device 20 further includes a substantially L-shaped cutter seat 22 mounted on a mediate portion of the rotation shaft 21 to rotate therewith, and the movable cutter 23 is secured on the cutter seat 22 by a plurality of locking bolts 230. The film cutting device 20 further includes a smooth board 19 mounted on the first end of the frame 10 and located at a first side of the fixed cutter 25 for supporting the film 100, and a guide board 27 secured on the fixing rack 24 and located at a second side of the fixed cutter 25 for guiding the film 100.

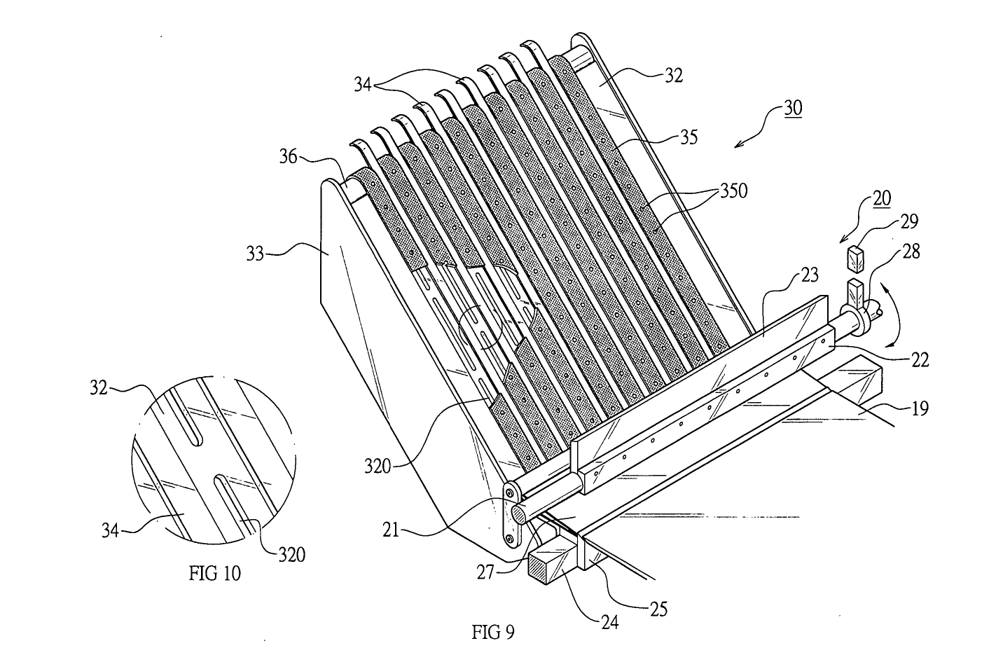

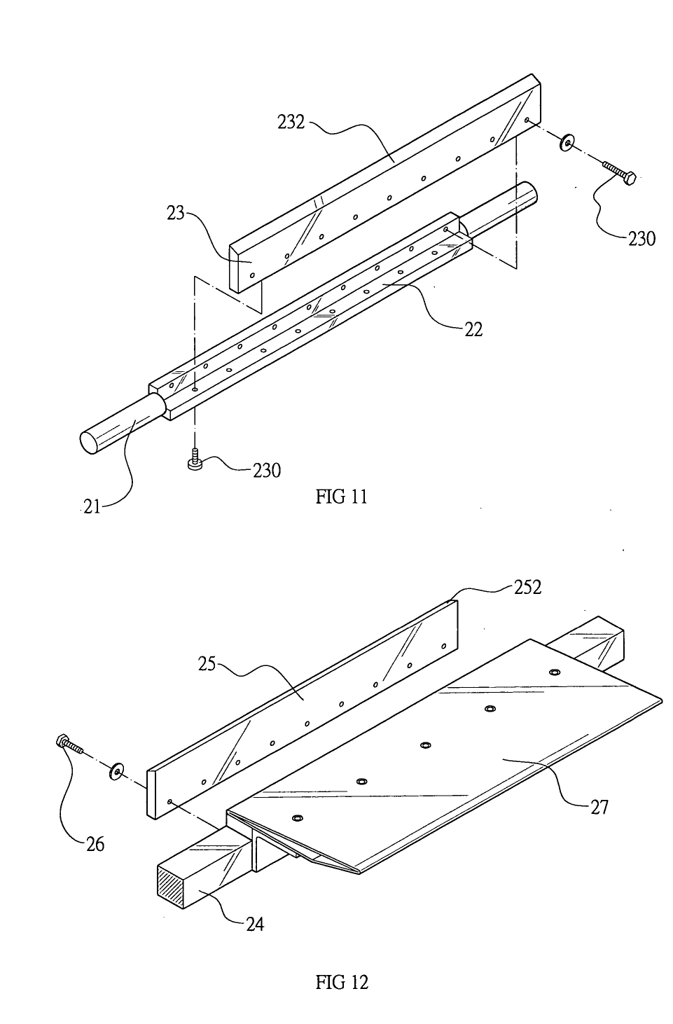

The film conveying device 30 includes a plurality of conveying belts 35 each movably mounted on the first end of the frame 10 for conveying the film 100 and each located beside the guide board 27 of the film cutting device 20, and an air box 32 mounted on the conveying belts 35 for sucking the film 100 on the conveying belts 35. The film conveying device 30 further includes two oblique side plates 33 mounted on the first end of the frame 10, and the conveying belts 35 are located between the two side plates 33. The film conveying device 30 further includes a plurality of parallel guide plates 34 mounted on the air box 32 and extended through the conveying belts 35 for guiding the conveying belts 35 to deliver the film 100 toward the intermediate conveying belt 12, a plurality of tension shafts 36, 37 and 38 mounted between the two side plates 33 and urged on the conveying belts 35 to provide a tension on the conveying belts 35, a guide hood 39 mounted on the air box 32, and a vacuum pump 31 mounted in the frame 10 and having a guide pipe 310 connected to the guide hood 39. In addition, each of the conveying belts 35 is formed with a plurality of through holes 350, and the air box 32 is formed with a plurality of elongated slots 320 (see FIG. 10) aligning with the through holes 350 of the conveying belts 35.

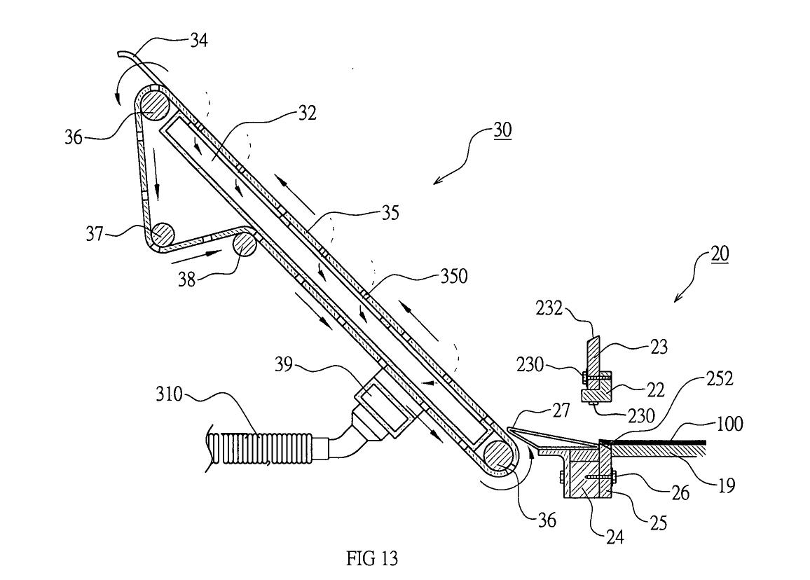

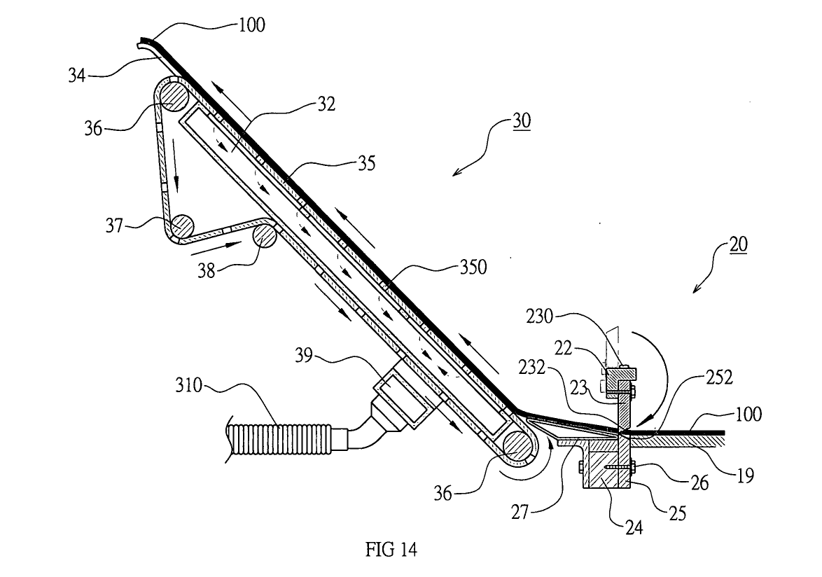

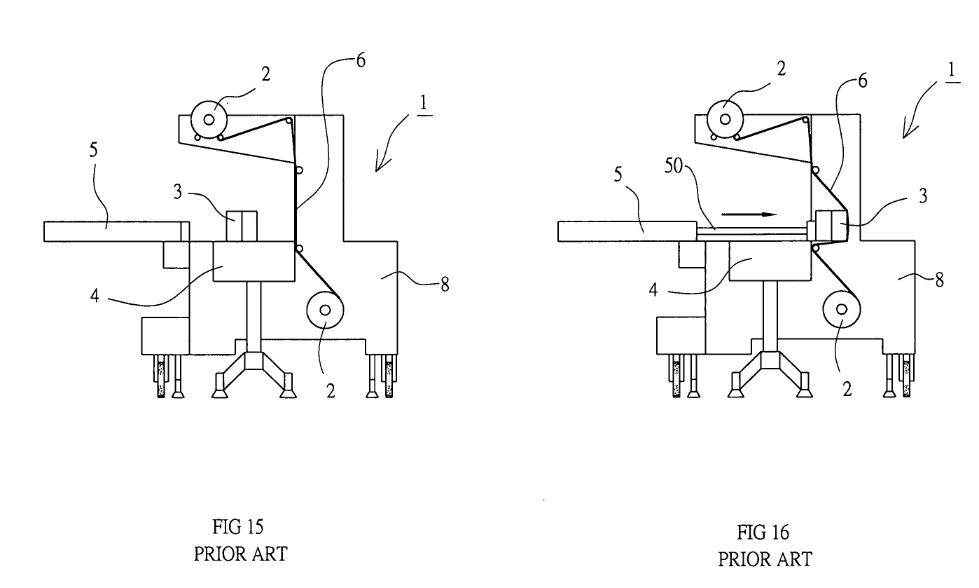

In practice, referring to FIGS. 13 and 14 with reference to FIG. 1, the inside of the air box 32 forms a negative pressure by operation of the vacuum pump 31 to produce a vacuum suction force on the conveying belts 35, so that the film 100 is attracted on and supported by the conveying belts 35 closely and smoothly, thereby facilitating the conveying belts 35 delivering the film 100 toward the intermediate conveying belt 12. In addition, the movable cutter 23 and the cutter seat 22 are rotated by the rotation shaft 21, so that the movable blade 232 of the movable cutter 23 is rotated to abut the fixed blade 252 of the fixed cutter 25 so as to cut the film 100 as shown in FIG. 14.

In addition, as shown in FIG. 9, the film cutting device 20 further includes a positioning ring 28 mounted on an end of the rotation shaft 21 to rotate therewith, and a sensor 29 mounted on the frame 10 and aligning with the positioning ring 28 to control the rotation angle of the rotation shaft 21 so as to position the movable cutter 23, so that the movable cutter 23 can cut the film 100 exactly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A packing machine, comprising:
a frame;
a film cutting device mounted in the frame and including a fixing rack secured on a first end of the frame, a fixed cutter secured on the fixing rack and having a distal end formed with an oblique fixed blade, a rotation shaft rotatably mounted on the first end of the frame and located above the fixing rack, and a movable cutter secured on the rotation shaft to rotate therewith and having a distal end formed with an oblique movable blade that is rotatable to abut the fixed blade of the fixed cutter; and
a film conveying device mounted in the frame and including a plurality of conveying belts each movably mounted on the first end of the frame and each located beside the film cutting device, and an air box mounted on the conveying belts for providing a suction action on the conveying belts.

2. The packing machine in accordance with claim 1, wherein the film cutting device further includes a cutter seat mounted on a mediate portion of the rotation shaft to rotate therewith, and the movable cutter is secured on the cutter seat.

3. The packing machine in accordance with claim 2, wherein the movable cutter is secured on the cutter seat by a plurality of locking bolts.

4. The packing machine in accordance with claim 2, wherein the cutter seat is substantially L-shaped.

5. The packing machine in accordance with claim 1, wherein the fixed cutter is secured on the fixing rack by a plurality of locking bolts.

6. The packing machine in accordance with claim 1, wherein the film cutting device further includes a smooth board mounted on the first end of the frame and located at a first side of the fixed cutter, and a guide board secured on the fixing rack and located at a second side of the fixed cutter.

7. The packing machine in accordance with claim 6, wherein each of the conveying belts is located beside the guide board of the film cutting device.

8. The packing machine in accordance with claim 1, wherein the film cutting device further includes a positioning ring mounted on an end of the rotation shaft to rotate therewith, and a sensor mounted on the frame and aligning with the positioning ring to control the rotation angle of the rotation shaft so as to position the movable cutter.

9. The packing machine in accordance with claim 1, wherein the film conveying device further includes two oblique side plates mounted on the first end of the frame, and the conveying belts are located between the two side plates.

10. The packing machine in accordance with claim 9, wherein the film conveying device further includes a plurality of tension shafts mounted between the two side plates and urged on the conveying belts to provide a tension on the conveying belts.

11. The packing machine in accordance with claim 1, wherein the film conveying device further includes a plurality of parallel guide plates mounted on the air box and extended through the conveying belts for guiding the conveying belts.

12. The packing machine in accordance with claim 1, wherein the film conveying device further includes a guide hood mounted on the air box, and a vacuum pump mounted in the frame and having a guide pipe connected to the guide hood.

13. The packing machine in accordance with claim 1, wherein each of the conveying belts is formed with a plurality of through holes, and the air box is formed with a plurality of elongated slots aligning with the through holes of the conveying belts.

14. The packing machine in accordance with claim 1, further comprising a first conveying belt mounted on the first end of the frame, a second conveying belt mounted on a second end of the frame, an intermediate conveying belt mounted on a mediate portion of the frame and located between the first conveying belt and the second conveying belt, wherein the film cutting device is mounted in and located at the first end of the frame, and the film conveying device mounted in and located at the first end of the frame.

15. The packing machine in accordance with claim 14, further comprising two loop-shaped chain units each mounted on the mediate portion of the frame and located beside the intermediate conveying belt, a storage shelf mounted in and located at the second end of the frame, a film roll mounted on the storage shelf, a delivery device mounted in and located at the mediate portion of the frame, a plurality of tension rods mounted in and located at the mediate portion of the frame, and a plurality of delivery rollers mounted in and located at the first end of the frame.

16. The packing machine in accordance with claim 15, wherein each of the two chain units includes a drive bar and a flexible belt.

17. The packing machine in accordance with claim 14, further comprising a sensing device mounted on the first conveying belt.
